(19) United States
(12) Patent Application Publication
(10) Pub. No.: US 2009/0166213 A1
(43) Pub. Date: Jul. 2, 2009

(54) PRODUCTION METHOD OF ELECTRO-DEPOSITED COPPER FOIL, ELECTRO-DEPOSITED COPPER FOIL OBTAINED BY THE PRODUCTION METHOD, SURFACE-TREATED COPPER FOIL OBTAINED BY USING THE ELECTRO-DEPOSITED COPPER FOIL AND COPPER-CLAD LAMINATE OBTAINED BY USING THE ELECTRO-DEPOSITED COPPER FOIL OR THE SURFACE-TREATED COPPER FOIL

(75) Inventors: Makoto Dobashi, Saitama (JP); Mitsuyoshi Matsuda, Saitama (JP); Sakiko Tomonaga, Saitama (JP); Hisao Sakai, Saitama (JP); Tomohiro Sakata, Saitama (JP); Ayumu Tateoka, Saitama (JP); Hiroshi Hata, Saitama (JP); Satoshi Mogi, Saitama (JP); Takeo Taguchi, Saitama (JP); Junshi Yoshioka, Saitama (JP)

Correspondence Address: GREENBLUM & BERNSTEIN, P.L.C., 1950 ROLAND CLARKE PLACE, RESTON, VA, 20191, US

(73) Assignee: MITSUI MINING & SMELTING CO., LTD., Tokyo (JP)

(21) Appl. No.: 12/089,671

(22) PCT Filed: Oct. 31, 2006
(86) PCT No.: PCT/JP2006/321701

§ 371 Date: Apr. 9, 2008

(30) Foreign Application Priority Data
Oct. 31, 2005 (JP) 2005-317174
Oct. 30, 2006 (JP) 2006-294778

(51) Int. Cl. C25D 3/38; B32B 15/04

(52) U.S. Cl. 205/296; 205/50

(57) ABSTRACT

An object of the present invention is to provide a production method which enables efficient production of an electro-deposited copper foil with further lower profile when compared to the low-profile electro-deposited copper foils which have been supplied to the market and is excellent in mechanical strength. For the purpose of achieving the object, a production method adopted obtains the electro-deposited copper foil by electrolyzing a sulfuric acid based copper electrolytic solution which contains a quaternary ammonium salt polymer having cyclic structure and chlorine, wherein for the quaternary ammonium salt polymer contained in the sulfuric acid based copper electrolytic solution, a DDAC dimer or higher polymer is used. For the quaternary ammonium salt polymer, a diallyl dimethyl ammonium chloride polymer having a number average molecular weight of 300 to 10000 is preferably used. The sulfuric acid based copper electrolytic solution preferably contains bis(3-sulfopropyl) disulfide or 3-mercapto-1-propanesulfonic acid that is a compound having a mercapto group.

### TECHNICAL FIELD

The present invention relates to a production method of an electro-deposited copper foil, an electro-deposited copper foil obtained by the production method, a surface-treated copper foil obtained by using the electro-deposited copper foil and a copper-clad laminate obtained by using the electro-deposited copper foil or the surface-treated copper foil. In particular, the present invention relates to a production method of an electro-deposited copper foil characterized in that the deposit side thereof is of a low profile.

### BACKGROUND ART

Electro-deposited copper foil has been widely used as a base material for printed wiring boards. On both electronic and electric devices in which printed wiring boards have been applied have been required down sizing i.e. miniaturization and weight reducing. For the purpose to perform down sizing in electronic and electric devices, pitch of signal circuits in the printed wiring boards should be as fine as possible. As a result, in production process of the printed wiring boards, thinner copper foil has been used to reduce over-etching time in circuits forming process by etching to improve the etching factor of the circuits to be formed.

In addition, electronic and electric devices to be miniaturized and reduced weight are also required to be high performance at the same time. As a result, for the purpose to assure wider device-mounting areas as possible in limited areas in printed wiring boards, improving of the etching factors at the time of circuit formation has been performed. In particular, in the applications such as tape automated bonding (TAB) boards and/or chip on film (COF) boards on which IC chips and the like are directly mounted, to improve the etching factors more, copper foils having lower profiles than those used in conventional printed wiring boars have been required. It is to be noted that the term “low profile” as referred to herein means that the roughness in the bonding interface between a copper foil and a resin substrate is low.

To solve such problems, Patent Document 1 discloses a production method of an electro-deposited copper foil which is characterized by using a sulfuric acid based copper plating solution containing a copolymer of diallyl dialkyl ammonium salt and sulfur dioxide in electrolysis of a sulfuric acid based copper plating solution. In addition, it is preferred to contain polyethylene glycol, chlorine and 3-mercapto-1-sulfonic acid in the sulfuric acid based copper plating solution. The electro-deposited copper foil obtained by the production method has small surface roughness (deposit side roughness) on the side to be bonded to the insulating substrate. Also it discloses that a low profile (roughness) of approximately Rz=1.0±0.5 μm is achieved in a 10 μm thick electro-deposited copper foil.

In addition, Patent Document 2 discloses a method for producing an electro-deposited copper foil with small surface roughness on the deposit side and excellent in elongation without using gelatin, glue or the like. In the production method of an electro-deposited copper foil by the electrolysis of a sulfuric acid based copper plating solution, a sulfuric acid based copper plating solution characterized by containing polyethylene glycol, chlorine and 3-mercapto-1-sulfonic acid is used. The electro-deposited copper foil obtained by the production method has small surface roughness (deposit side roughness) of the side to be bonded to the insulating substrate. Also it discloses that a low profile (roughness) of approximately Rz=1.5±0.5 μm is achieved in a 10 μm thick electro-deposited copper foil.

Patent Document 3 discloses a production method for an electro-deposited copper foil in which a copper electrolytic solution which contains additives composed of an amine compound having a specific formulation wherein the amine compound having a specific formulation is obtained by addition reaction of a compound having one or more epoxy groups in one molecule thereof with an amine compound, and an organic sulfur compound is used. In the description of the Examples, the electro-deposited copper foil obtained by the production method has the following properties: the surface roughness Rz falls in a range from 0.90 to 1.20 μm, the elongation as received is 6.62 to 8.90%, the tensile strength as received is 30.5 to 37.9 kgf/mm², the elongation in elevated temperature is 12.1 to 18.2%, the tensile strength in elevated temperature is 20.1 to 22.3 kgf/mm².

Patent Document 4 discloses a production method of an electro-deposited copper foil in which a copper electrolytic solution which contains additives composed of a quaternary amine compound having a specific formulation wherein the quaternary amine compound having a specific formulation is obtained by addition reaction of a compound having one or more epoxy groups in one molecule thereof with an amine compound followed by the nitrogen to be quaternary, and an organic sulfur compound is used. In the description of the Example, the electro-deposited copper foil obtained by the production method has the following properties: the surface roughness Rz falls in a range from 0.94 to 1.23 μm, the elongation as received is 6.72 to 9.20%, the tensile strength as received is 30.5 to 37.2 kgf/mm², the elongation in elevated temperature is 11.9 to 18.2%, the tensile strength in elevated temperature is 19.9 to 23.4 kgf/mm².

On the other hand, Patent Document 5 discloses a surface-treated electro-deposited copper foil characterized in that a bonding surface is formed by applying a roughening treatment to the deposit side of a electro-deposited copper foil wherein the surface roughness Rz of the deposit side of the electro-deposited copper foil is the same as or smaller than the surface roughness Rz of the shiny side of the electro-deposited copper foil. In addition, in the production of the electro-deposited copper foil, an electrolytic solution which contains a mercapto group-containing compound, chloride ion, a low molecular weight glue of 10000 or less in molecular weight and a polymer polysaccharide is used. Specifically, the mercapto group-containing compound is a salt of 3-mercapto-1-propanesulfonic acid, the molecular weight of the low molecular weight glue is 3000 or less and the polymer polysaccharide is hydroxyethyl cellulose.

When electro-deposited copper foils are produced by using these production methods, excellent low-profile deposit sides can be formed to exhibit extremely excellent properties as low-profile electro-deposited copper foil.

[Patent Document 1] Japanese Patent Laid-Open No. 2004-35918

[Patent Document 2] Japanese Patent Laid-Open No. 2004-162144

[Patent Document 3] Japanese Patent Laid-Open No. 2004-107786

[Patent Document 4] Japanese Patent Laid-Open No. 2004-137588

[Patent Document 5] Japanese Patent Laid-Open No. 9-143785

### DISCLOSURE OF THE INVENTION

However, the clock frequency in the personal computers which is a representative of electronic or electric devices has been increased and the operation speed of personal computers has rapidly increased. Moreover, in addition to just data processing as a fundamental role of conventional computers, personal computers perform many additional functions to be used as AV devices. In other words, personal computers are required to be a music player, a DVD recorder/player, a TV tuner/recorder, a TV telephone and the like.

As a result, monitors of personal computers are not just data monitors, but are required to perform image quality which enables long-time audiovisual operation even when images of movies and the like are displayed. Further, monitors provided with such quality are required to be supplied much at low price. As for the above-described monitors, liquid crystal monitors are most widely used, and above-described tape automated bonding (TAB) boards and chip on film (COF) boards are generally used as the drivers for the liquid crystal panels of such liquid crystal monitors. As a result, for the purpose of making monitors capable for high-definition television images, formation of finer circuits is required for the drivers above-described.

Further, a copper foil used for current collectors used in lithium ion batteries is also preferred to have smooth surface. In other words, when a copper foil having smooth surface is used as a current collector, it is also advantageous to obtain even thickness in the coated active material after coating a slurry containing active material on the copper foil. The active material coated on the negative electrode is loaded expansion and contraction during charging and discharging repeatedly. As a result, the dimensional change of the copper foil as a current collector which should follow such expansion and contraction becomes large, and tearing of the copper foil may occur if the copper foil fails to follow the expansion and contraction. So, to withstand the repetition of expansion and contraction, the copper foil to be a current collecting material are required to have enough tensile strength and enough elongation. Also, when a dielectric layer for a capacitor is formed on a copper foil by the sol-gel method, it is also advantageous to use a copper foil having smooth surface.

Under above-described situations, requirement for electro-deposited copper foils that are further lower in profile and are also excellent in mechanical strength when compared to low-profile electro-deposited copper foils which have been supplied is exist in the market.

Under such situations, the present inventors have made an intensive study on production of an electro-deposited copper foil by using a sulfuric acid based copper electrolytic solution which contains a quaternary ammonium salt polymer having cyclic structure and electrolyze the copper electrolytic solution to solve the above-described problems. As a result, the present inventors have thought up the fact that the production conditions described below enables stable production of a low-profile electro-deposited copper foil superior to conventional low-profile copper foils, and the profile of the resulted electro-deposited copper foil has small deviation in quality. The present invention will be described below.

Production method of low-profile electro-deposited copper foil: The production method of an electro-deposited copper foil to obtain the electro-deposited copper foil by electrolyzing a sulfuric acid based copper electrolytic solution containing a quaternary ammonium salt polymer having cyclic structure and chlorine is characterized in that a diallyl dimethyl ammonium chloride dimer or higher polymer is used for the quaternary ammonium salt polymer contained in the sulfuric acid based copper electrolytic solution.

In the production method of an electro-deposited copper foil according to the present invention, the quaternary ammonium salt polymer contained in the sulfuric acid based copper electrolytic solution is a diallyl dimethyl ammonium chloride polymer having a number average molecular weight of 300 to 10000.

In the production method of an electro-deposited copper foil according to the present invention, the sulfuric acid based copper electrolytic solution contains one or more selected from bis(3-sulfopropyl) disulfide and 3-mercapto-1-propanesulfonic acid that is a compound having a mercapto group, and the concentration of the selected compound(s) is preferably 0.5 ppm to 200 ppm.

In the production method of an electro-deposited copper foil according to the present invention, the concentration of the quaternary ammonium salt polymer in the sulfuric acid based copper electrolytic solution is preferably 1 ppm to 150 ppm.

In the production method of an electro-deposited copper foil according to the present invention, the chlorine concentration in the sulfuric acid based copper electrolytic solution is preferably 5 ppm to 120 ppm.

The sulfuric acid based copper electrolytic solution in the production method of an electro-deposited copper foil according to the present invention is preferably electrolyzed at a solution temperature of 20° C. to 60° C. and with a current density of 15 A/dm² to 90 A/dm².

Electro-deposited copper foil obtained by the production method of an electro-deposited copper foil according to the present invention: The electro-deposited copper foil obtained by the production method of an electro-deposited copper foil according to the present invention is an electro-deposited copper foil obtained by electrolyzing the sulfuric acid based copper electrolytic solution, which is characterized in that the surface roughness (Rzjis) of the deposit side is 1.0 μm or less of a low profile and the gloss (Gs(60°)) of the deposit side of 400 or more.

Surface-treated copper foil according to the present invention: The surface-treated copper foil according to the present invention is a surface-treated copper foil obtained by applying one or two or more selected from a roughening treatment, a rust-proofing treatment and a silane coupling agent treatment to the deposit side of the electro-deposited copper foil.

The surface roughness (Rzjis) of the bonding surface of the surface-treated copper foil to the insulating resin substrate is 2 μm or less of a low profile.

Copper clad laminate according to the present invention: By using the electro-deposited copper foil or the surface-treated copper foil having been described above, a high-quality copper-clad laminate particularly suitable for the production of printed wiring boards can be obtained.

When the production method of an electro-deposited copper foil according to the present invention is applied, an electro-deposited copper foil with further lower profile and superior mechanical strength when compared to the low-profile electro-deposited copper foils which have been supplied to the market can be produced with reduced quality deviation and a satisfactory efficiency. In addition, the electrolytic solution used in the production method of an electro-deposited copper foil according to the present invention is different from those used in the production of the conventional low-profile electro-deposited copper foils in the composition, so it is excellent in solution stability and can be stably used in long-term electrolysis and does not raise the cost even with consideration on the waste solution treatment.

In addition, excellent properties in both low profile and mechanical strength of the low-profile electro-deposited copper foil obtained by the production method can be maintained even after applying the above-described surface treatment to the deposit side of the low-profile electro-deposited copper foil to obtain surface-treated copper foil. As a result, the low-profile electro-deposited copper foil obtained by the production method is suitable for formation of fine-pitch circuits of tape automated bonding (TAB) boards and chip on film (COF) boards wherein such copper foils with low profile is strongly required for fine-pitch circuits, and is also suitable for use in the fields of, for example, current collecting materials constituting negative electrodes of lithium ion secondary batteries.

### BEST MODE FOR CARRYING OUT THE INVENTION

Production method of the electro-deposited copper foil according to the present invention: The production method of the low-profile electro-deposited copper foil according to the present invention uses a sulfuric acid based copper electrolytic solution containing a quaternary ammonium salt polymer having cyclic structure wherein a diallyl dimethyl ammonium chloride (hereinafter, referred to as “DDAC”) dimer or higher polymer is used for the quaternary ammonium salt polymer. In other words, the above-described method does not use the monomer of DDAC, and selectively uses a DDAC dimer or higher polymer. It is to be noted that the DDAC of the quaternary ammonium salt polymer takes a cyclic structure when forming the polymer structure. In such a way, a portion of the cyclic structure is constituted with the nitrogen atom of the quaternary ammonium. In the DDAC Polymer, the above-described cyclic structure is provably any one of a four-membered ring to a seven-membered ring or an admixture of these polymers. So, chemical formula 1, a compound having five-membered ring structure is shown below as a representative of these polymers. As shown clearly in chemical formula 1, the DDAC Polymer takes a polymer structure which is dimeric or higher with respect to DDAC. In other words, the monomer of DDAC does not enable the profile of the surface of the electro-deposited copper foil lower. In addition, the main chain of the DDAC Polymer is preferably constituted only with carbon and hydrogen.

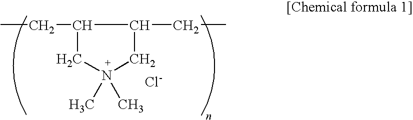

Using of the sulfuric acid based copper electrolytic solution having a composition containing dimer or higher polymer of DDAC enables a stable production of an electro-deposited copper foil having a low-profile surface superior to that of conventional low-profile electro-deposited copper foils.

In the dimer or higher polymer of DDAC, DDAC Polymer having too large molecular weight results in a decreased production capacity of the low-profile electro-deposited copper foil. As for polymeric structure, the concerned dimer or higher polymer is a dimer to 150-mer, and more preferably a tetramer to 14-mer. The monomer or a polymer larger than 150-mer does not enable the profile of the surface of the electro-deposited copper foil lower but cause deviation in profile. On the contrary, when the dimer or higher polymer of DDAC is used within the more preferable range of polymers, the profile of the surface of the electro-deposited copper foil can be lowered most stably with minimized deviation.

From the viewpoint of the number average molecular weight, optimal substances as the DDAC dimer or higher polymer preferably have a number average molecular weight falling in a range from 300 to 10000. The number average molecular weight of the DDAC Polymer less than 300 means increased rate of the monomer, so the profile lowering tends to be difficult as shown in the below-described comparative examples. However, the profile lowering of the electro-deposited copper foil according to the present invention, as referred to herein, does not mean that only the profile measured by a stylus-type surface roughness measuring instrument is preferable. But it means that when compared to low-profile copper foils obtained by conventional electrolysis methods, the gloss of the deposit side is definitely different, and the co-planarity of the deposit side is drastically improved. When the number average molecular weight of the DDAC Polymer exceeds 10000, even if the concentrations of other additives contained together are regulated, the DDAC Polymer cannot enable the profile of the electro-deposited copper foil lower and the deviation in the profile of the deposit side of the obtained electro-deposited copper foil becomes large. Even when the concerned number average molecular weight is 10000 or less, if exceeds 7000, the deviation of the profile of the deposit side of the obtained electro-deposited copper foil tends to be remarkably large, for example, and the concentration of bis(3-sulfopropyl) disulfide (hereinafter, refereed to as “SPS”) contained together is required to be 100 ppm or more. As a result, in consideration of the variations of the general control levels of the electrolysis operation conditions such as the solution temperature and/or concentrations, the DDAC Polymer of 300 to 7000 in number average molecular weight is more preferably used, and the DDAC Polymer of 600 to 2500 in number average molecular weight is furthermore preferably used. However, in a DDAC Polymer production, the monomer of DDAC might be remained. However, it can be clearly stated that amount of the remaining monomer of DDAC is small and is not required to be eliminated.

It is to be noted that the above-described number average molecular weights are the values measured by the following measurement method. Specifically, each of the samples was dissolved in a solvent, and the molecular weight was measured by gel permeation chromatography (GPC) under the following conditions. As the detector, a multi-angle laser light scattering photometer (MALS) was used. The value of “the second virial coefficient×concentration” was assumed to be 0 mol/g, and for the standard sample for use in calculation of the refractive index deviation against to the concentration change (dn/dc), polyethylene oxide (SRM1924) obtained from NIST was used.

### [GPC Measurement Conditions]

Column: TSK gel α-4000, α-2500 (φ7.8 mm×30 cm); manufactured by Tosoh Corp.

Solvent: Aqueous system:methanol=50:50 (volume ratio)

Flow rate: 0.504 mL/min

Temperature: 23° C.±2° C.

Detector: MALS (DAWN-EOS type); Wyatt Technology

Wavelength: 690 nm

Temperature: 23° C.±2° C.

Further, the concentration of the DDAC Polymer used in the production method of the electro-deposited copper foil according to the present invention, as the quaternary ammonium salt polymer in the sulfuric acid based copper electrolytic solution, is determined in consideration of the relation with the concentration of SPS or 3-mercapto-1-propanesulfonic acid (hereinafter, referred to as “MPS”). The concentration of the DDAC Polymer is preferably 1 ppm to 150 ppm, more preferably 2 ppm to 100 ppm, and furthermore preferably 3 ppm to 80 ppm. When the concentration of the DDAC Polymer in the sulfuric acid based copper electrolytic solution is less than 1 ppm, the deposit side of the electro-deposited copper foil becomes rough so as to make it difficult to obtain an electro-deposited copper foil with lowered profile no matter how the concentration of SPS and/or MPS is increased. Also, when the concentration of the DDAC Polymer in the sulfuric acid based copper electrolytic solution exceeds 150 ppm, the copper deposition condition becomes unstable so as to make it difficult to obtain a low-profile electro-deposited copper foil.

The sulfuric acid based copper electrolytic solution used in the production method of an electro-deposited copper foil according to the present invention enables to obtain a low-profile electro-deposited copper foil more exactly by containing therein one or more selected from SPS and MPS that is a compound having a mercapto group. And the concentration of the one or more selected from SPS and MPS is preferably 0.5 ppm to 200 ppm, more preferably 4 ppm to 150 ppm, and furthermore preferably 4 ppm to 50 ppm. When the concentration of SPS or MPS is less than 0.5 ppm, the deposit side of the electro-deposited copper foil becomes rough so as to make it difficult to obtain a low-profile electro-deposited copper foil. Also, when the concentration of SPS or MPS exceeds 200 ppm, the effect to smooth the deposit side of the obtained electro-deposited copper foil is not improved, and the electrodeposition condition may not be stable. It is to be noted that the term SPS or MPS as referred to in the present invention is used in the sense that the term contains the salt of SPS or MPS, respectively, and the described value of the concentration is given in terms of the amount of the sodium salt of 3-mercapto-1-propanesulfonic acid (hereinafter, referred to as “MPS-Na”). In addition, MPS takes the SPS structure through dimerization in the sulfuric acid based copper electrolytic solution. As a result, the concentration of SPS or MPS means the concentration including the substances added as SPS and/or MPS themselves, the salts such as MPS-Na, and in addition, the modified substances generated by polymerization into SPS and the like after being added to the electrolytic solution as MPS. The structural formula of MPS is shown in the following chemical formula 2, and the structural formula of SPS is shown in the following chemical formula 3. As can be seen from a comparison between these structural formulas, the SPS structure is the dimer of MPS.

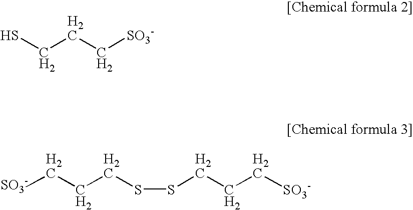

Further, the concentration of the chlorine in the sulfuric acid based copper electrolytic solution is preferably 5 ppm to 120 ppm, and more preferably 10 ppm to 50 ppm. When the chlorine concentration is less than 5 ppm, the deposit side of the electro-deposited copper foil becomes rough to lose the low profile. On the other hand, when the chlorine concentration exceeds 120 ppm, the deposit side of the electro-deposited copper foil becomes rough, the electrodeposition cannot be stabilized and low-profile deposit side cannot be formed.

As described above, the component balance between SPS or MPS, DDAC Polymer and chlorine in the sulfuric acid based copper electrolytic solution is most important, and when the quantitative balance among these deviates from the above-described ranges, the deposit side of the electro-deposited copper foil consequently becomes rough to lose the low profile.

In the sulfuric acid based copper electrolytic solution as referred to in the present invention, a solution in which the copper concentration may be approximately 50 g/l to 120 g/l and the free-sulfuric acid concentration may be approximately 60 g/l to 250 g/l.

In addition, when an electro-deposited copper foil is produced by using the above-described sulfuric acid based copper electrolytic solution, it is preferable to carry out the electrolysis at the solution temperature of 20° C. to 60° C. and a current density of 15 A/dm² to 90 A/dm². When the solution temperature is lower than 20° C., the deposition rate is reduced, and it may enlarge the deviations of the mechanical properties such as the elongation and the tensile strength. On the other hand, when the solution temperature exceeds 60° C., the water evaporation increase to vary the solution concentration rapidly, and the deposit side of the obtained electro-deposited copper foil cannot keep preferable smoothness. In addition, the more preferable range of the solution temperature is 40° C. to 55° C. Next, when the current density is less than 15 A/dm², the deposition rate of copper is slow and the industrial productivity is poor. On the other hand, when the current density exceeds 90 A/dm², the surface roughness of the deposit side of the obtained electro-deposited copper foil becomes large to lose the low profile. The more preferable range of the current density is 40 A/dm² to 70 A/dm².

### <Electro-Deposited Copper Foil Obtained by the Production Method According to the Present Invention>

The electro-deposited copper foil obtained by the production method according to the present invention is characterized in that the surface roughness (Rzjis) of the deposit side is 1.0 μm or less of a low profile and the gloss (Gs(60°)) of the deposit side is 400 or more. In a strict sense, the surface roughness of the deposit side of an electro-deposited copper foil is recognized to vary with the thickness of the electro-deposited copper foil in conventional sense. However, according to the production method of an electro-deposited copper foil of the present invention, all of the electro-deposited copper foils with the thickness of 450 μm or less which can be produced as electro-deposited copper foils, the surface roughness and gloss of the deposit side of the obtained electro-deposited copper foil can satisfy the specifications that the surface roughness (Rzjis) of the deposit side is 1.0 μm or less of a low profile and the gloss (Gs(60°)) of the deposit side is 400 or more.

The “electro-deposited copper foil” in the present invention means an electro-deposited copper foil without surface treatment, and may sometime be referred to “drum foil”, “peeled deposited foil” or the like. In the description of the present invention, this is simply referred to as the “electro-deposited copper foil”. For the production of the electro-deposited copper foil, a continuous production method is adopted generally. The copper sulfate based solution is supplied into a gap between a drum-shaped rotating cathode and a lead base anode or a dimensionally stable anode (DSA) disposed to face the rotating cathode along to the shape of the rotating cathode. And copper is deposited on the drum surface of the rotating cathode through the electrolytic reaction. The thus deposited copper forms a foil shape, and the foil thus formed is continuously peeled from the rotating cathode and is wound up to obtain an electro-deposited copper foil. At this stage, the surface treatment, rust-proofing treatment and the like has not been carried out. So, the copper just after the electrodeposition is in an activated condition to be easily oxidized by the oxygen in the air.

The side of the peeled electro-deposited copper foil having been in contact with the rotating cathode has a surface shape to which the shape of the mirror-finished surface of the rotating cathode is transferred, and hence this side is a shiny and smooth surface. As a result, this surface is referred to as the shiny side. In contrast, the surface shape of the side where copper has been deposited generally shows an angular shape because the crystal growth rate of copper varies depending on the individual crystal planes. As a result, the surface is referred to as the matte side or the deposit side. Usually, the deposit side is bonded to an insulating layer when a copper-clad laminate is produced. The smaller is the surface roughness of the deposit side, the electro-deposited copper foil is said to be the more excellent low-profile electro-deposited copper foil. Further, in the electro-deposited copper foil according to the present invention, the surface roughness of the deposit side becomes smoother than those of the shiny sides of the copper foils produced by using popular rotating drums, so the term “deposit side” is used without using the term “matte side”.

In addition, the electro-deposited copper foil is generally subjected to a surface treatment step to apply a roughening treatment and a rust-proofing treatment on the deposit side. The roughening treatment applied to the deposit side includes a treatment in which fine copper particles are deposited on the deposit side by electrolysis in a copper sulfate solution under the so-called burnt plating conditions, followed by seal plating carried out by electrolysis under the level plating conditions to prevent the detachment of the fine copper particles. As a result, the deposit side to which fine copper particles are deposited is referred to as the “roughened surface.” Successively, in the surface treatment step, a rust-proofing treatment is applied to the both sides of the electro-deposited copper foil by processing such as a zinc, zinc alloy or chromium base plating followed by drying. After winding-up of the foil, a production of an electro-deposited copper foil finishes. A product thus obtained is generally referred to as a “surface-treated foil.”

The electro-deposited copper foil according to the present invention has the properties of the surface roughness (Rzjis) of less than 1.0 μm and the gloss [Gs(60°)] of 400 or more. In addition, the surface roughness (Rzjis) is less than 0.6 μm and the gloss [Gs(60°)] is over 600 more preferably. First, gloss will be descried. The gloss [Gs(60°)] as referred to herein means the intensity of the reflected light with a reflection angle of 60° as measured by irradiating the surface of the electro-deposited copper foil with a measurement light at an incident angle of 60°. The incident angle as referred to herein be such that 0° is the right angle against to the surface light irradiated. In addition, according to JIS Z 8741-1997, there are described five mirror gloss measurement methods different in incident angle from each other, and an appropriate incident angle is stated to be selected according to the gloss of the sample. Among such methods, the adoption of the incident angle of 60° is described to enable a wide range of measurement covering from a low-gloss sample to a high-gloss sample. As a result, the incident angle of 60° has been mainly adopted for the gloss measurement of the electro-deposited copper foils according to the present invention and the like.

In general, the surface roughness Rzjis has been used as a parameter for the evaluation of the smoothness of the deposit side of an electro-deposited copper foil. However, just with Rzjis, only a set of asperity information in the height direction is obtained, but a set of information about the period of wave and the undulation of the surface cannot be obtained. By the way, the gloss is a parameter reflecting both sets of information. So the use of the gloss in combination with Rzjis enables an overall judgment on the surface including various parameters such as the roughness, period of wave and undulation with the uniformities thereof in the surface.

The electro-deposited copper foil according to the present invention satisfies the specifications that the surface roughness (Rzjis) of the deposit side is less than 1.0 μm and the gloss [Gs(60°)] of the deposit side is 400 or more. In other words, such an electro-deposited copper foil which can assure the qualities so as to fall in such ranges as described above has never be supplied in the market. In addition, application of the below-described production method also enables the supply of an electro-deposited copper foil having a surface roughness (Rzjis) of less than 0.6 μm and a gloss [Gs(60°)] of 700 or more on a deposit side. Here, the upper limit of the gloss is not yet determined, but is approximately 800 in terms of the [Gs(60°)] on the basis of an empirical estimation. The gloss measurement in the present invention was carried out by using a glossmeter (model VG-2000, manufactured by Nippon Denshoku Industries Co., Ltd.) and according to JIS Z 8741-1997 specifying the gloss measurement method.

No boundary is shown on the thickness of the electro-deposited copper foil as referred to herein. This is because there is a desirable tendency that with the increase of the thickness, the roughness of the deposit side becomes smaller and the gloss is also improved. If the upper limit is daringly set, the targets are such electro-deposited copper foils falling in a thickness range of 450 μm or less wherein the thickness of 450 μm is the limit which can create commercial profit even when electro-deposited copper foils are industrially produced.

In addition, no boundary is imposed on the lower limit of the surface roughness (Rzjis) of the deposit side. Although depending on the sensitivity of the measurement apparatus, empirically the lower limit of the surface roughness is approximately 0.1 μm. However, in actual measurements, deviations are found and the lower limit that can be assured of the measurement values is considered to be approximately 0.2 μm.

Even when a roughening treatment and a rust-proofing treatment are applied to such smooth deposit side, it is natural to obtain a surface-treated copper foil with a roughened surface further lower in profile than conventional low-profile surface-treated copper foils. In addition, when the surface-treated copper foil is bonded to an insulating resin substrate, a physical anchoring effect can be obtained in preferable level. Further, because the roughness in the bonding interface has become small, less chemical solution such as an etching solution may penetrates into the interface. It means that chemical resistance of the interface is suitable.

The mechanical properties of the electro-deposited copper foil according to the present invention are such that the tensile strength as received state is 33 kgf/mm² or more and the elongation as received state is 5% or more. In addition, it is preferred that after heating (180° C.×60 minutes, in air atmosphere), the tensile strength is 30 kgf/mm² or more and the elongation is 8% or more.

In addition, in the present invention, by optimizing the production conditions, the electro-deposited copper foil can show more excellent mechanical properties such that the tensile strength as received state of 38 kgf/mm² or more and the tensile strength after heating (180° C.×60 minutes, in air atmosphere) of 33 kgf/mm² or more. As a result, such preferable mechanical properties can sufficiently withstand the use of flexible printed wiring boards with bend, and are also suitable for use in current collectors for negative electrodes of lithium ion secondary batteries and the like which is undergoing actions of expansion and contraction.

### <Surface-Treated Copper Foil According to the Present Invention>

The surface-treated copper foil according to the present invention is a copper foil obtained by applying one or two or more selected from a roughening treatment, a rust-proofing treatment and a silane coupling agent treatment to the deposit side of the electro-deposited copper foil. In other words, the electro-deposited copper foil as used herein is “an electro-deposited copper foil in which the surface roughness (Rzjis) of the deposit side is 1.0 μm or less of a low profile, and the gloss (Gs(60°)) of the deposit side thereof is 400 or more,” and is “an electro-deposited copper foil obtained by using a sulfuric acid based copper electrolytic solution obtained by adding a quaternary ammonium salt polymer having cyclic structure.”

For the roughening treatment as referred to herein, either method selected from the following two methods can be adopted: a method in which fine metal particles are formed on the deposit side of an electro-deposited copper foil and a method in which a roughened surface is formed by etching the deposit side of an electro-deposited copper foil. Here, former method of forming fine metal particles in which copper fine particles are formed on the deposit side will be described. The roughening step is constituted with two steps. One of the steps is a burnt plating step in which fine copper particles are deposited on the deposit side of the electro-deposited copper foil and another step is a seal plating step in which the detachment of the fine copper particles is prevented.

In the step in which fine copper particles are deposited on the deposit side of the electro-deposited copper foil by electrolysis, the burnt plating conditions are adopted as the electrolysis conditions. As a result, the composition of the solution generally used in a step in which fine copper particles are deposited on the deposit side is set such that the copper ion concentration is set to be low to ease establishment of the burnt plating conditions. The burnt plating conditions are not particularly limited, and are arranged in consideration of the characteristics of the production line. For example, if a copper sulfate based solution is used, the conditions can be arranged as followings. Copper concentration is 5 to 20 g/l, the sulfuric acid concentration is 50 to 200 g/l, other additives of α-naphthoquinoline, dextrin, glue, thiourea and the like are contained if required, the solution temperature is 15 to 40° C. and the current density is 10 to 50 A/dm².

And the seal plating step for preventing the detachment of the fine copper particles is a step in which copper is deposited uniformly under the level plating conditions to prevent the detachment of the deposited fine copper particles by covering the fine copper particles. It means that the same solution with the above-described solution used in the bulk copper formation cell can be used as a copper-ion source in this step. The level plating conditions are not particularly limited, and are arranged in consideration of the characteristics of the production line. For example, if a copper sulfate based solution is used, the conditions can be arranged as followings. Copper concentration is 50 to 80 g/l, the sulfuric acid concentration is 50 to 150 g/l, the solution temperature is 40 to 50° C. and the current density is 10 to 50 A/dm².

Next, the method for forming the rust-proofing layer will be described. The rust-proofing layer serves as a layer for preventing the surface of the electro-deposited copper foil from oxidation and corrosion which disturb the production process of copper-clad laminates and the production process of printed wiring boards. As the methods used in the rust-proofing treatment, either selected from the following methods can be used without causing any problem. One is an organic rust-proofing method using benzotriazole, imidazole or the like and another is an inorganic rust-proofing method using zinc, chromate, a zinc alloy or the like. It is recommended to select a rust-proofing method according to the application which uses the electro-deposited copper foil. When an organic rust-proofing method is applied, methods such as immersion coating, showering coating or electro coating can be adopted to form an organic rust-proofing agent layer. When an inorganic rust-proofing method is applied, methods in which a rust-proofing element is deposited by electrolysis on the surface of an electro-deposited copper foil, and other methods such as a so-called substitution deposition method can be adopted. For example, when a zinc rust-proofing treatment is carried out, a zinc pyrophosphate plating bath, a zinc cyanide plating bath, a zinc sulfate plating bath and the like can be used. For example, a zinc pyrophosphate plating bath is used, the conditions can be set as followings. Zinc concentration is 5 to 30 g/l, the concentration of potassium pyrophosphate is 50 to 500 g/l, the solution temperature is 20 to 50° C., the pH is 9 to 12 and the current density is 0.3 to 10 A/dm².

In addition, the silane coupling agent treatment is a treatment chemically improves the adhesion to the insulating layer-constituting material applied after finishing all of the roughening treatment, the rust-proofing treatment and the like. The silane coupling agent used in the silane coupling agent treatment is not particularly limited. It can be selected in consideration of the properties of the insulating layer-constituting material, the plating solution and the like used in the printed wiring board production process. A silane coupling agent used can be selected from an epoxy-functional silane coupling agent, an amino-functional silane coupling agent, a mercapto-functional silane coupling agent and the like.

More specifically, the above-described coupling agent is preferably selected from the similar kind of the coupling agents used in glass cloth prepreg for printed wiring boards; examples of applicable coupling agents include vinyltrimethoxysilane, vinylphenyltrimethoxysilane, γ-methacryloxypropyltrimethoxysilane, γ-glycidoxypropyltrimethoxysilane, 4-glycidylbutyltrimethoxysilane, γ-aminopropyltriethoxysilane, N-β-(aminoethyl)-γ-aminopropyltrimethoxysilane, N-3-(4-(3-aminopropoxy)butoxy)propyl-3-aminopropyltrimethoxysilane, imidazolesilane, triazinesilane, and γ-mercaptopropyltrimethoxysilane.

Further, the surface-treated copper foil obtained by using the electro-deposited copper foil according to the present invention after finishing the above-described surface treatment on the surface is characterized in that the surface roughness (Rzjis) of the surface to be bonded to the insulating layer-constituting material is 2 μm or less of a low profile. When the surface-treated copper foil having such a low-profile roughened surface is bonded to an insulating layer-constituting material, an adhesion with preferable serviceability can be assured. Thus, as a base material, heat resistance properties, chemical resistance and peel strength with preferable serviceability can be obtained.

The copper-clad laminate according to the present invention: The above-described electro-deposited copper foil is a foil without a roughening treatment, a rust-proofing treatment and the like, and copper-clad laminates can be obtained by bonding with various insulating layer-constituting materials including rigid prepregs such as a glass-epoxy substrate and a glass-polyimide substrate and flexible substrates such as a polyimide resin film through a conventional process such as hot press processing. Alternatively, when a flexible copper-clad laminate is produced, a polyimide resin substrate layer can also be formed by a casting method.

However, in many cases, for the purpose to assure the adhesion between the electro-deposited copper foil and the insulating layer-constituting material, the roughening treatment, the rust-proofing treatment, the silane coupling agent treatment and the like which can improve the adhesion between the electro-deposited copper foil and the insulating layer-constituting material may applied to the bonding surface of the electro-deposited copper foil according to requirement. And thus, the treated surface of the electro-deposited copper foil and the insulating layer-constituting material are bonded to each other. In selecting the low-profile bonding surface, in the case of the electro-deposited copper foil according to the present invention, the deposit side is smoother than the shiny side, and hence either of the deposit side and the shiny side can be selected as the bonding surface.

Again, the copper-clad laminate includes so-called rigid copper-clad laminates and flexible copper-clad laminates such as COF tape carriers. It is clearly stated that as the production method of the copper-clad laminate, any of the conventional methods can be used. Hereinafter, Examples according to the present invention will be described.

### EXAMPLES

Production of electro-deposited copper foil: In each of present Examples, a sulfuric acid based copper electrolytic solution with a copper concentration of 80 g/l and a free sulfuric acid concentration of 140 g/l was prepared for common use, and the SPS or MPS concentration, the DDAC Polymer concentration having a predetermined number average molecular weight (309, 1220, 2170 or 7250) and the chlorine concentration were arranged as shown in Table 1. It is to be noted that the DDAC Polymer having a number average molecular weight of 309 is described as the dimer of DDAC. SPS or MPS was added in the sodium salt.

TABLE 1

| | | | Quaternary ammonium | | |
|---|---|---|---|---|---|
| | | | salt polymer | | |
| | | | (DDAC Polymer) | | |
| | Concentra- | | | Number | Chlorine |
| | tion of SPS | | Concentra- | average | concen- |
| | or MPS (ppm) | | tion | molecular | tration |
| | MPS | SPS | (ppm) | weight | (ppm) |
| Examples | 7 | — | 5 | 309 | 10 |
| 1 & 2 | | | | (dimer) | |
| Examples | | | | 1220 | |
| 3 & 4 | | | | | |
| Examples | | | | 2170 | |
| 5 & 6 | | | | | |
| Example 7 | — | 120 | 71 | 7250 | 40 |
| Example 8 | — | 200 | | | |
| Comparative | 7 | — | | 150 | |
| Example 1 | | | | | |

Concentration of SPS or MPS: Given in terms of the sodium salt of 3-mercapto-1-propanesulfonic acid
DDAC Polymer: Diallyl dimethyl ammonium chloride polymer

Electrolysis was performed as followings. A titanium plate was used as the cathode after polishing the surface with a #2000 polishing paper to adjust the surface roughness to be 0.20 μm in terms of Ra, and a DSA was used as the anode. The solution temperature was set at 50° C.; and the current density was set at 60 A/dm² in Examples 1 to 6 and at 52 A/dm² in Examples 7 and 8. Thus, total 8 electro-deposited copper foils including five 12-μm thick electro-deposited copper foils in Examples 1, 3, 5, 7 and 8, and three 210-μm thick electro-deposited copper foils in Examples 2, 4 and 6 were prepared. The crystal structure of each of these electro-deposited copper foils was confirmed to be substantially a random orientation across the thickness direction.

The surface roughness and the gloss of each of these electro-deposited copper foils were examined as follows. The examination results of the deposit sides are shown in Table 2. The surface roughness (0.20 μm in terms of Ra) of the above-described titanium plate electrode was a value verified by evaluating the shiny sides of the obtained electro-deposited copper foils.

Surface roughness: Measurement was made by using a surface roughness measuring instrument (SE-3500, manufactured by Kosaka Laboratory Ltd.) according to JIS B 0601-1994, and the obtained Rz values were used as the Rzjis values.

Gloss: Measurement was made by using a glossmeter (model VG-2000, manufactured by Nippon Denshoku Industries Co., Ltd.) according to JIS Z 8741-1997 specifying the gloss measurement method.

TABLE 2

| | thick- | | | | | | | | | | | Surface |
|---|---|---|---|---|---|---|---|---|---|---|---|---|
| | ness of | | | | | | | | | | | roughness |
| | Electro- | Deposit side roughness | | | | | | Tensile strength | | Elongation | | of surface- |
| | deposited | (μm) | | | | Gloss | | (kgf/mm²) | | percentage (%) | | treated copper |
| | copper | Rzjis | | Ra | | Gs(60°) | | Received | After | Received | After | foil, Rzjis |
| Sample | foil (μm) | Ave. | S.D. | Ave. | S.D. | Ave. | S.D. | state | heating | state | heating | (μm) |
| Example 1 | 12 | 0.41 | 0.02 | 0.09 | 0.01 | 721 | 7.1 | 38.5 | 35.6 | 7.8 | 11.1 | ≦2 |
| Example 2 | 210 | 0.48 | 0.03 | 0.11 | 0.01 | 715 | 7.2 | — | | — | | ≦2 |
| Example 3 | 12 | 0.53 | 0.01 | 0.15 | 0.01 | 710 | 7.5 | 37.7 | 33.2 | 7.0 | 9.5 | ≦2 |
| Example 4 | 210 | 0.68 | 0.03 | 0.17 | 0.02 | 677 | 6.3 | — | | — | | ≦2 |
| Example 5 | 12 | 0.49 | 0.02 | 0.11 | 0.01 | 689 | 7.0 | 40.0 | 36.0 | 8.2 | 12.5 | ≦2 |
| Example 6 | 210 | 0.61 | 0.04 | 0.16 | 0.02 | 680 | 7.2 | — | | — | | ≦2 |
| Example 7 | 12 | 0.54 | 0.03 | 0.17 | 0.04 | 683 | 8.1 | 34.9 | 31.1 | 5.5 | 8.8 | ≦2 |
| Example 8 | 12 | 0.50 | 0.04 | 0.19 | 0.05 | 686 | 12.5 | 34.3 | 30.6 | 6.2 | 8.2 | ≦2 |
| Compara- | 12 | 1.01 | 0.05 | 0.24 | 0.02 | 293 | 7.8 | 37.2 | 35.5 | 5.3 | 6.8 | 3 |
| tive | 210 | 1.10 | 0.07 | 0.31 | 0.03 | 233 | 8.1 | — | | — | | 3 |
| Example 1 | | | | | | | | | | | | |
| Compara- | 12 | 0.85 | 0.16 | 0.18 | 0.03 | 283 | 3.4 | 36.2 | 32.4 | 4.0 | 5.6 | 3 |
| tive | 210 | 0.70 | 0.11 | 0.14 | 0.04 | 221 | 2.8 | — | | — | | 3 |
| Example 2 | | | | | | | | | | | | |
| Compara- | 12 | 0.83 | 0.12 | 0.17 | 0.04 | 374 | 3.6 | 31.4 | 26.8 | 3.5 | 5.8 | 3 |

| | | | | | | | | | | |
|---|---|---|---|---|---|---|---|---|---|---|
| tive | 210 | 1.22 | 0.38 | 0.31 | 0.05 | 386 | 3.1 | — | — | 3 |
| Example 3 | | | | | | | | | | |

The average values and the standard deviations of the surface roughness of the deposit side listed in Table 2 are the average values and the standard deviations obtained from the values measured at 30 points. Also for the gloss, the average values and the standard deviations obtained from the values measured at 30 points are shown. The surface roughness of a surface-treated copper foil shows the average value obtained from the values measured at 30 points on the surface after roughening treatment.

Preparation of surface-treated copper foil: Deposition of the fine copper particles to the deposit side to obtain roughened surface followed by the rust-proofing treatment was performed for each of the above-described electro-deposited copper foils as the surface treatment. Before the formation of the roughened surface, the surface of the electro-deposited copper foil was cleaned by acid pickling. In the acid pickling, electrodeposited copper foils were immersed for 30 seconds in a dilute sulfuric acid having a concentration of 100 g/l and a solution temperature of 30° C.

After finishing the acid pickling treatment, the burnt plating step for depositing fine copper particles to the deposit side and the seal plating step for preventing the detachment of the fine copper particles were performed as the step of forming fine copper nodules on the deposit side of the electro-deposited copper foil. In the former burnt plating step for depositing fine copper particles, electrolysis in a copper sulfate based solution having a copper concentration of 15 g/l and a free sulfuric acid concentration of 140 g/l where the electro-deposited copper foil was used as the cathode and a DSA was used as the anode was carried out for 5 seconds at a solution temperature of 25° C. with a current density of 25 A/dm².

Thus, fine copper particles were formed on the deposit side, then as the seal plating step for preventing the detachment of the fine copper particles, copper was evenly deposited under the level plating conditions to cover the fine copper particles. The electrolysis conditions were set to be the level plating conditions. Electrolysis in a copper sulfate based solution having a copper concentration of 70 g/l and a free sulfuric acid concentration of 80 g/l where the electro-deposited copper foil was used as the cathode and a DSA was used as the anode was carried out for 10 seconds at a solution temperature of 45° C. with a current density of 25 A/dm².

After finishing the above-described roughening treatment, the rust-proofing treatment is applied to both sides of the electro-deposited copper foil. Here, an inorganic rust-proofing under the below-described conditions was adopted. A zinc rust-proofing treatment by electrolysis in a zinc sulfate bath having a sulfuric acid concentration of 70 g/l and a zinc concentration of 20 g/l where the electro-deposited copper foil was used as the cathode and a zinc plate was used as the anode was carried out for 5 seconds at a solution temperature of 40° C. with a current density of 15 A/dm².

Further, in the case of present Examples, a chromate layer was formed by electrolysis on the above-described zinc rust-proofing layer. The electrolysis in a solution having a chromic acid concentration of 5.0 g/l and a pH of 11.5 where the electro-deposited copper foil was used as the cathode and a SUS plate was used as the anode was carried out for 5 seconds at a solution temperature of 35° C. with a current density of 8 A/dm².

After finishing the rust-proofing treatment as described above, the electro-deposited copper foil was rinsed with water, and immediately a silane coupling agent was adsorbed on the rust-proofing layer of the roughened surface in a silane coupling agent treatment cell. The solution used was prepared by adding γ-glycidoxypropyltrimethoxysilane to de-ionized water as a solvent to have a concentration of 5 g/l. The adsorption was carried out by splashing the solution to the foil.

After finishing the silane coupling agent treatment, the electro-deposited copper foil pass through a furnace heated with an electric heater to adjust the temperature of the atmosphere in the furnace to elevate the foil temperature at 140° C. over a period of 4 seconds. Thus, the moisture of the foil was removed by evaporation, and the condensation reaction of the silane coupling agent was promoted. In this way, finally, five 12-μm thick surface-treated electro-deposited copper foils and three 210-μm thick surface-treated copper foils were obtained. The surface roughnesses of the roughened surfaces after the surface treatment of 12-μm thick foils and 210-μm thick foils are separately listed in Table 2.

### COMPARATIVE EXAMPLES

### Comparative Example 1

In Comparative Example 1, an electro-deposited copper foil was obtained under the same conditions as in Examples 1 to 6 except that the monomer of DDAC was used in place of the DDAC Polymer in the copper electrolytic solution used in Examples. The examination results of the electro-deposited copper foil such as the surface roughness and the gloss of the deposit side are shown in Table 2 together with the results for Examples. Thereafter, a surface-treated copper foil was obtained in the same manner as in Example 1, and the surface roughness of the roughened surface thereof is shown in Table 2 together with the results for Examples.

### Comparative Example 2

Comparative Example 2 is a trace experiment of Example 1 disclosed in Patent Document 1. A sulfuric acid based copper plating solution was prepared as followings. Copper sulfate (reagent) and sulfuric acid (reagent) were dissolved in pure water to prepare an aqueous solution having a copper sulfate concentration (in terms of pentahydrate) of 280 g/l and a free sulfuric acid concentration of 90 g/l. To the solution, a copolymer of diallyl dialkyl ammonium salt and sulfur dioxide (manufactured by Nitto Boseki Co., Ltd.; trade name: PAS-A-5; weight average molecular weight: 4000; 4 ppm), polyethylene glycol (average molecular weight: 1000; 10 ppm) and MPS (1 ppm) were added. Further, the chlorine concentration of the solution was adjusted at 20 ppm by using sodium chloride.

Then, electrolysis was performed as followings. A titanium plate was used as the cathode after polishing the surface with a #2000 polishing paper to adjust the surface roughness to be 0.20 μm in terms of Ra, and a lead plate was used as the anode. The solution temperature was set at 40° C.; and the current density was set at 50 A/dm² to obtain 12-μm thick electro-deposited copper foil and 210-μm thick electro-deposited copper foil. The measurement results of these electro-deposited copper foils such as the surface roughness and the gloss of the deposit side are shown in Table 2 together with the results for Examples.

Thereafter, these electro-deposited copper foils were treated in the same manner as in Example 1 to obtain surface-treated copper foils. The surface roughnesses of the roughened surfaces are shown in Table 2 together with the results of Examples.

### Comparative Example 3

A sulfuric acid based copper electrolytic solution having a copper concentration of 90 g/l and a free sulfuric acid concentration of 110 g/l was prepared, and was passed through an activated carbon filter for purification treatment. Then, the electrolytic solution was prepared by adding MPS-Na (1 ppm), hydroxyethyl cellulose (5 ppm) as a polysaccharide and a low molecular weight glue (number average molecular weight of 1560; 4 ppm) respectively to the electrolytic solution, and sodium chloride was also added to adjust the chlorine concentration to be 30 ppm. Electrolysis was carried out in the electrolytic solution at a solution temperature of 58° C. with a current density of 50 A/dm² where a titanium plate electrode which surface was polished with a #2000 polishing paper to adjust the surface roughness to be 0.20 μm in terms of Ra was used as the cathode and a DSA was used as the anode. Thus, a 12-μm thick electro-deposited copper foil and a 210-μm thick electro-deposited copper foil were obtained. The examination results of these electro-deposited copper foils such as the surface roughness and the gloss of the deposit side are shown in Table 2 together with the results for Examples.

Thereafter, these electro-deposited copper foils were treated in the same manner as in Example 1 to obtain surface-treated copper foils. The surface roughnesses of the roughened surfaces are shown in Table 2 together with the results of Examples.

<Comparison within Examples 1, 3, 5 and Examples 7, 8>

Here, the cases where either MPS or SPS both having a mercapto group was used were compared. As is clear from Table 2, the surface roughness and the gloss of the deposit sides, the tensile strengths as received state and after heating, the elongations as received state and after heating and the surface roughnesses of the surface-treated copper foils are approximately same in Examples 1, 3, 5, 7 and 8. It means that it is confirmed that even when SPS or MPS used in preparation of the copper electrolytic solutions has added in MPS as itself or in the salt(s) such as MPS-Na, or in SPS, effects obtained are almost same.

<Comparison within Examples and Comparative Examples>

Surface roughness of the deposit side: A comparison of the surface roughnesses in terms of Ra shows not so large differences between the deposit sides of the electro-deposited copper foils according to the present invention obtained in Examples 1 to 8 and the deposit sides of the electro-deposited copper foils obtained in Comparative Examples 1 to 3 in both for the average values and for the standard deviations. However, when a surface roughness in terms of Rzjis are compared, the electro-deposited copper foils obtained in Examples have the lower-profile deposit sides than the deposit sides of the electro-deposited copper foils obtained in Comparative Examples in the average values. A comparison within Comparative Example 1 with Examples clearly shows that the monomer of DDAC is inferior in smoothing effect to the DDAC Polymers. And in comparison of the standard deviations (and coefficients of variation), the deposit sides of the electro-deposited copper foils obtained in Examples are excellent in surface uniformity because it exhibit smaller deviation i.e. stable profiles. In addition, such tendency is found independent from the foil thickness.

In other words, as long as judged from the profiles (Rzjis) of the deposit sides measured by using a stylus-type surface roughness measuring instrument, the electro-deposited copper foils obtained in Comparative Examples 1 to 3 fall within a preferable range of low-profile electro-deposited copper foils. However, the electro-deposited copper foils according to Examples 1 to 8 are further uniform and excellent in lower profile performance. In addition, a comparison of Comparative Example 2 with Examples makes it clear that among the ammonium salt polymers, the DDAC Polymers having the main chain constituted only with carbon and hydrogen have been able to attain uniform and excellent profile lowering.

In addition, even a comparison on the surface-treated electro-deposited copper foils, same result is obtained in the comparison of the surface roughnesses (Rzjis) of the electro-deposited copper foils. In other words, the surface roughnesses (Rzjis) of the roughened surfaces of the surface-treated copper foils which are obtained by using the electro-deposited copper foils in Comparative Examples exhibit approximately 3 μm. In contrast, the surface roughness (Rzjis) of the roughened surfaces of the surface-treated copper foils obtained by using the electro-deposited copper foils obtained in Examples 1 to 8 all exhibit 2 μm or less It means that more excellent low-profile products have been obtained in Examples than Comparative Examples.

Gloss: When the average values of the individual glosses of the electro-deposited copper foils obtained in Examples 1 to 8 are compared to the average values of the individual glosses of the electro-deposited copper foils obtained in Comparative Examples, the glosses of the electro-deposited copper foils obtained in Examples 1 to 8 have fairly higher values, in quite different range. It means that when the individual electro-deposited copper foils obtained in Examples 1 to 8 are compared to the individual electro-deposited copper foils obtained in Comparative Examples 1 to 3, the electro-deposited copper foils obtained in Examples 1 to 8 are flatter, closer to mirror and uniform in deposit surface.

Tensile strength and elongation: When the individual electro-deposited copper foils of Examples obtained by applying the preferable production conditions are compared with the electro-deposited copper foils obtained in Comparative Examples, the tensile strengths both as received state and after heating of the electro-deposited copper foils obtained in Examples compete with those of the electro-deposited copper foils obtained in Comparative Examples 1 and 2. However, the electro-deposited copper foil obtained in Comparative Example 3 clearly show differences from those in Examples, and moreover it is characterized in that the tensile strength as received state is small and the tensile strength decreases after heating. In the elongation, the electro-deposited copper foil of Examples are superior to individual Comparative Examples, and the differences between Examples and Comparative Examples become remarkable when the elongations after heating are compared. Consequently, the electro-deposited copper foils according to the present invention can be preferably used in those applications with thermal history.

### INDUSTRIAL APPLICABILITY

The production method of an electro-deposited copper foil according to the present invention enables production and efficient supply of the low-profile electro-deposited copper foils further more stable in quality as compared to low-profile electro-deposited copper foils that have been supplied to the market. In addition, the electro-deposited copper foils obtained as the products are provided with flat surface by far exceeding low-profile electro-deposited copper foils that have been supplied to the market. As a result, even when the deposit sides of the electro-deposited copper foils are subject to surface treatment and to roughening treatment, low-profile surface-treated copper foils can be easily obtained which has never been obtained. Consequently, such surface-treated copper foils are suitable for use in formation of fine-pitch circuits of tape automated bonding (TAB) boards, chip on film (COF) boards and the like. In addition, in the electro-deposited copper foils according to the present invention, the surface roughness of the deposit sides is lower than that of the shiny sides, and hence both sides perform glossy smooth surfaces. Further, as compared to conventional low-profile electro-deposited copper foils, the electro-deposited copper foil according to the present invention is more excellent in both tensile strength and elongation. It means that the electro-deposited copper foil according to the present invention is also suitable for use as current collecting materials constituting negative electrodes of lithium ion secondary batteries.

1. A production method of an electro-deposited copper foil to obtain the electro-deposited copper foil by electrolyzing a sulfuric acid based copper electrolytic solution containing a quaternary ammonium salt polymer having cyclic structure and chlorine, which is characterized in that a diallyl dimethyl ammonium chloride dimer or higher polymer is used for the quaternary ammonium salt polymer contained in the sulfuric acid based copper electrolytic solution.

2. The production method of an electro-deposited copper foil according to claim 1, wherein the quaternary ammonium salt polymer contained in the sulfuric acid based copper electrolytic solution is a diallyl dimethyl ammonium chloride polymer having a number average molecular weight of 300 to 10000.

3. The production method of an electro-deposited copper foil according to claim 1, wherein the sulfuric acid based copper electrolytic solution contains one or more selected from bis(3-sulfopropyl) disulfide and 3-mercapto-1-propanesulfonic acid that is a compound having a mercapto group, and the concentration of the selected compound(s) is 0.5 ppm to 200 ppm.

4. The production method of an electro-deposited copper foil according to claim 1, wherein the concentration of the quaternary ammonium salt polymer in the sulfuric acid based copper electrolytic solution is 1 ppm to 150 ppm.

5. The production method of an electro-deposited copper foil according to claim 1, wherein the chlorine concentration in the sulfuric acid based copper electrolytic solution is 5 ppm to 120 ppm.

6. The production method of an electro-deposited copper foil according to claim 1, wherein the sulfuric acid based copper electrolytic solution is electrolyzed at a solution temperature of 20° C. to 60° C. and with a current density of 15 A/dm² to 90 A/dm².

7. An electro-deposited copper foil obtained by the production method according to claim 1 which is characterized in that the surface roughness (Rzjis) of the deposit side is 1.0 μm or less of a low profile and the gloss (Gs(60°)) of the deposit side of 400 or more.

8. A copper-clad laminate obtained by using the electro-deposited copper foil according to claim 7.

9. A surface-treated copper foil obtained by applying one or two or more selected from a roughening treatment, a rust-proofing treatment and a silane coupling agent treatment to the deposit side of the electro-deposited copper foil according to claim 7.

10. The surface-treated copper foil according to claim 9, characterized in that the surface roughness (Rzjis) of the bonding surface of the surface-treated copper foil to the insulating resin substrate is 2 μm or less of a low profile.

11. A copper-clad laminate obtained by using the surface-treated copper foil according to claim 9.
